(19) United States
(12) Patent Application Publication
(10) Pub. No.: US 2013/0037169 A1
(43) Pub. Date: Feb. 14, 2013

(54) FILTERED WATER DISPENSER

(71) Applicants: GARY VOLINO, Norcross, GA (US); Craig Cochran, Atlanta, GA (US); Maureen Carroll, Atlanta, GA (US); Jeff Juskowich, Mableton, GA (US); Frank Barry, Birmingham, AL (US)

(72) Inventors: GARY VOLINO, Norcross, GA (US); Craig Cochran, Atlanta, GA (US); Maureen Carroll, Atlanta, GA (US); Jeff Juskowich, Mableton, GA (US); Frank Barry, Birmingham, AL (US)

(21) Appl. No.: 13/164,883

(22) Filed: Aug. 12, 2011

(51) Int. Cl. B67C 3/02; B67C 3/26; B67D 7/76

(52) U.S. Cl. 141/69; 141/351; 141/285; 141/146; 141/152

(57) ABSTRACT

A liquid dispensing apparatus for filling at least one bottle with liquid is presented. The apparatus has an unfiltered water source, a filtration assembly, a dispensing assembly, and a bottle retention assembly. The dispensing assembly is configured to dispense filtered water into the interior volume of the at least one bottle.

### FIELD OF THE INVENTION

This invention relates generally to water dispensing, and more particularly to devices for filtration of water and dispensing water into bottles or the like.

### BACKGROUND OF THE INVENTION

Bottled water has become prevalent in developed countries in the past two decades. While clean water is essential for life, the cost to produce clean water is significant. Eco-costs include manufacturing, trucking, shelving, and marketing. Meeting just the annual U.S. demand for plastic bottles requires enough oil to keep 100,000 cars on the road for a year. Of course, the 70 million empty water bottles the U.S. produces per day can be recycled, but the sad truth is, about 86 percent of them end up in the trash.

Eco friendly consumers need a device to provide them with clean water in a way they can reuse their bottles and reduce the amount of waste produced.

### SUMMARY

Presented herein is a liquid dispensing apparatus for filling at least one bottle with liquid. In one aspect, the apparatus comprises an unfiltered water source, a filtration assembly, a dispensing assembly, and a bottle retention assembly. The filtration assembly is in fluid communication with the unfiltered water source and is configured to substantially filter at least some of the impurities from the water, providing filtered water.

The dispensing assembly is configured to dispense filtered water into the interior volume of the at least one bottle. The dispensing assembly can dispense filtered water into a plurality of bottles, as well. In one aspect, the dispensing assembly comprises at least one valve assembly configured to move from an open position in which filtered water is permitted to flow therethrough, and a closed position in which filtered water is prevented from flowing therethrough.

In one exemplified aspect, there is at least one flow path in communication with the filtration assembly and the dispensing assembly to permit the filtered water to flow from the filtration assembly to the dispensing assembly. As each of the bottles is filled with liquid, the volume of air contained within the interior volume of the bottle is displaced. In one aspect, the dispensing apparatus further comprises at least one vent channel in communication with dispensing assembly and the atmosphere to permit air to flow from the interior volume of the bottle to the atmosphere when filtered water flows into the interior volume of the bottle.

Related methods of operation are also provided. Other apparatuses, methods, systems, features, and advantages of the dispensing apparatus will be or become apparent to one with skill in the art upon examination of the following figures and detailed description. It is intended that all such additional apparatuses, methods, systems, features, and advantages be included within this description, be within the scope of the dispensing apparatus, and be protected by the accompanying claims.

### DESCRIPTION OF THE FIGURES

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 is perspective view of one aspect of a dispensing apparatus;

FIG. 2 is a front elevational view of the dispensing apparatus of FIG. 1, showing a retention assembly in a lower, non-engaged position;

FIG. 3 is a side elevational view of the dispensing apparatus of FIG. 1, showing a retention assembly in a lower, non-engaged position;

FIG. 4 is a partial cut-away front elevational view of the dispensing apparatus of FIG. 1, showing a retention assembly in a lower, non-engaged position, cut along line 4-4 of FIG. 3;

FIG. 5 is a front elevational view of the dispensing apparatus of FIG. 1, showing a retention assembly in a higher, engaged position;

FIG. 6 is a partial cut-away front elevational view of the dispensing apparatus of FIG. 1, showing a retention assembly in a higher, engaged position, cut along line 4-4 of FIG. 3;

FIG. 7 is a partially exploded perspective view of the dispensing apparatus of FIG. 1;

FIG. 8 is a perspective view of one aspect of a manifold for a dispensing apparatus;

FIG. 9 is perspective view of one aspect of a dispensing assembly and filtration assembly for a dispensing apparatus;

FIG. 10 is a front elevational view of one aspect of a bottle for use with a dispensing apparatus;

FIG. 11 is a perspective view of portions of a retention assembly and dispensing assembly for a dispensing apparatus;

FIG. 12 is a perspective view of one aspect of a retention assembly and valve assembly for a dispensing apparatus, showing a retention assembly with a ramp;

FIG. 13 is a side elevational view of the retention assembly of FIG. 12;

FIG. 14 is a perspective view of one aspect of a dispensing apparatus, showing a reservoir lid that forms a flow path;

FIG. 15 is a perspective view of the dispensing apparatus of FIG. 14, showing the reservoir lid in the open position;

FIG. 16 is a partially transparent top plan view of the dispensing apparatus of FIG. 1;

FIG. 17 is a cut away side elevational view of the dispensing apparatus of FIG. 1, cut along line 17-17 of FIG. 16, showing a portion of the flow paths when the valve assembly is in the closed position;

FIG. 18 is a cut away side elevational view of the dispensing apparatus of FIG. 1, cut along line 17-17 of FIG. 16, showing a portion of the flow paths and vent paths when the valve assembly is in the open position

FIG. 19 is a partial cut-away view of one aspect of a valve assembly for a dispensing apparatus, showing the valve in a closed position;

FIG. 20 is a partial cut-away view of the valve assembly of FIG. 19, showing the valve in an open position.

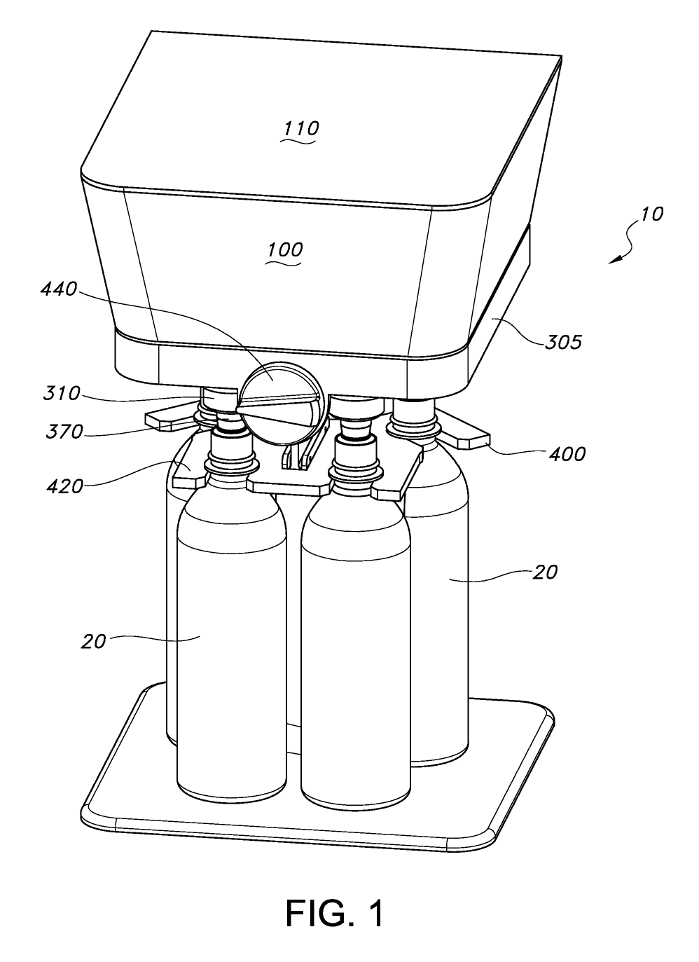

### DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “path” includes aspects having two or more paths unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

In one aspect, presented herein is a liquid dispensing apparatus 10 for filling at least one bottle 20 with liquid. While it is understood that the dispensing apparatus 10 can be configured to fill various bottles, the discussion will concentrate on bottled water bottles 20 having a neck 22, a bead 24, an interior volume 26, and defining a mouth 28.

In one aspect, the apparatus comprises an unfiltered water source 100, a filtration assembly 200, a dispensing assembly 300, and a bottle retention assembly 400. The unfiltered water source 100 is configured to provide unfiltered water that, by nature, contains at least some impurities. The unfiltered water source can comprise a reservoir 100, or it can be a pressurized source such as a conventional residential tap. For discussion purposes only, we will mainly focus on the reservoir aspect herein. In one aspect, the reservoir can hold a volume of liquid equal to or greater than the volume of liquid of the bottles for which it is designed to fill.

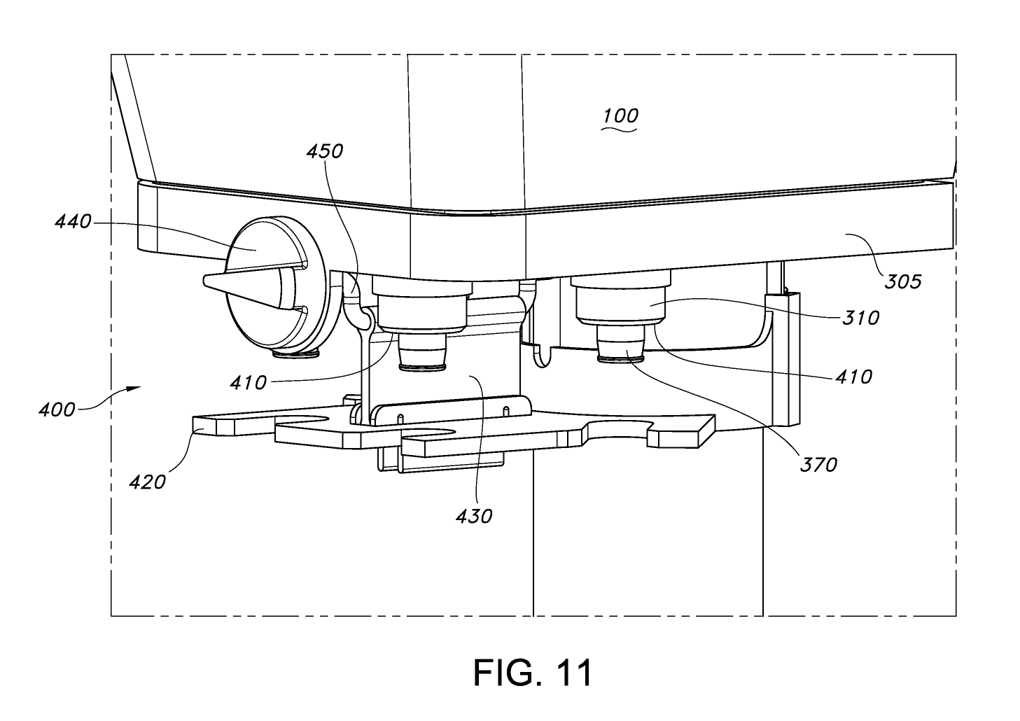

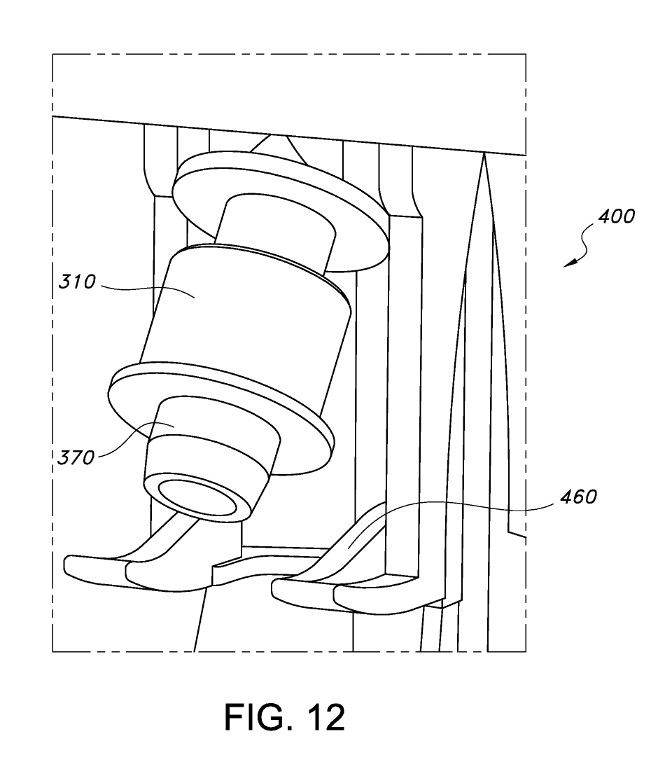

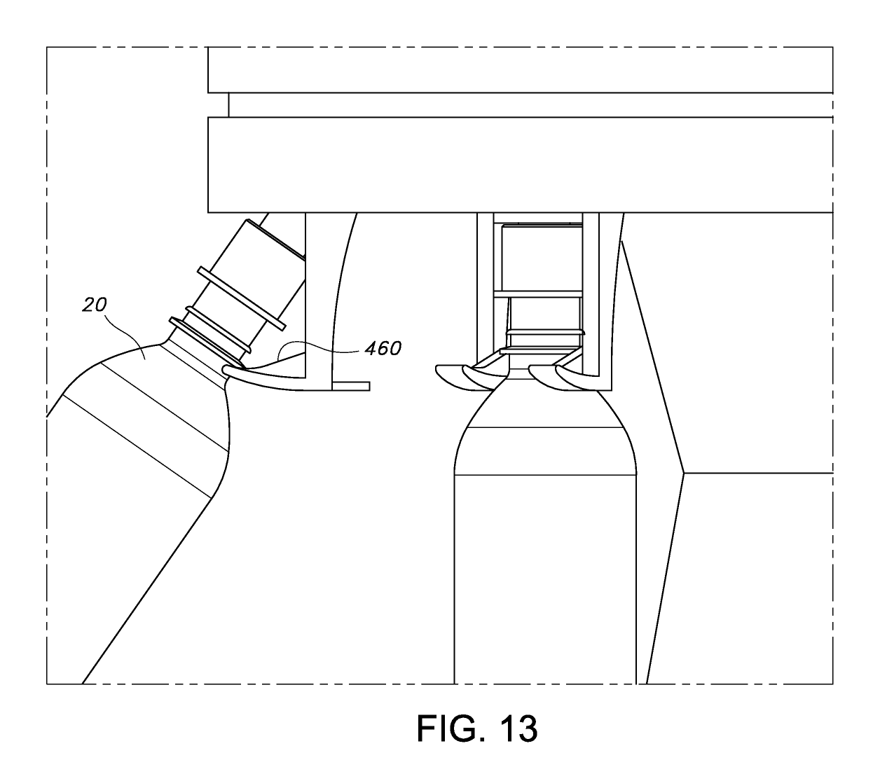

The filtration assembly 200 is in fluid communication with the unfiltered water source and is configured to substantially filter at least some of the impurities from the water, providing filtered water. The filtration assembly can comprise a standard charcoal filter 210 for filtering impurities, or other state of the art filters can be utilized. In one aspect, as shown in FIG. 11, the filtration assembly comprises a filter housing 220 defining a filter cavity 230 for receipt of the filter 210. In another aspect, the inlet of the filtration assembly 200 is positioned below the unfiltered water source 100 and, as such, the unfiltered water flows into the filter cavity 230 via gravity. There are several conventional manners in which the filtration can also occur, including but not limited to in line filters, gravity fed filters, pressure fed filters, and the like.

In an exemplified aspect, the filter cavity is surrounded by an annulus 232 through which filtered water can flow and egress toward the dispensing assembly 300. In this aspect, the outlet 240 is positioned below the lowest water level of the reservoir 100 such that the water flows up the annulus 232 and out of the outlet 240 via the artesian effect. It is contemplated, however, that the outlet of the filter cavity can be higher than the lowest water level of the reservoir and the filtered water flows up to the dispensing assembly via mechanical means. One such mechanical means can be, for example, a centrifugal pump.

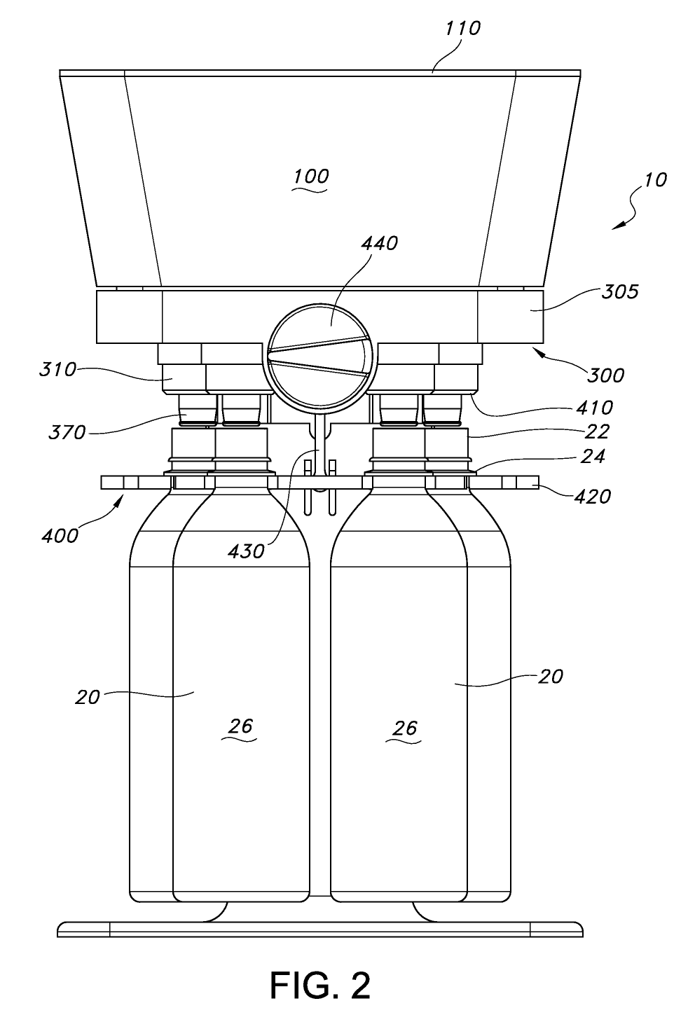

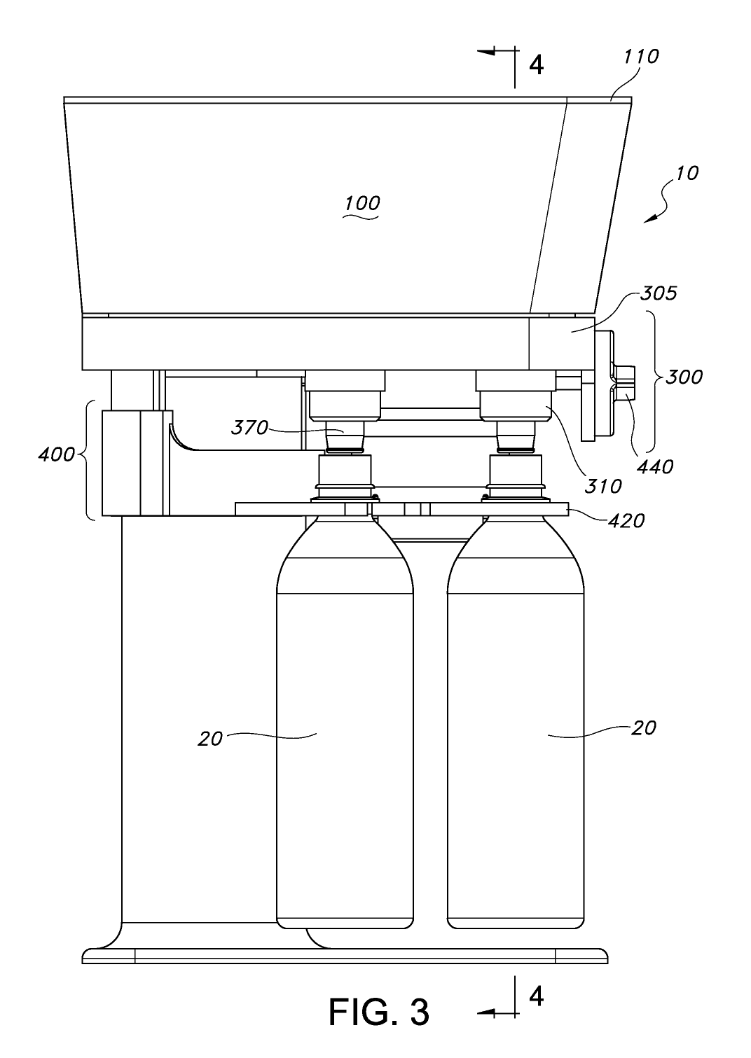

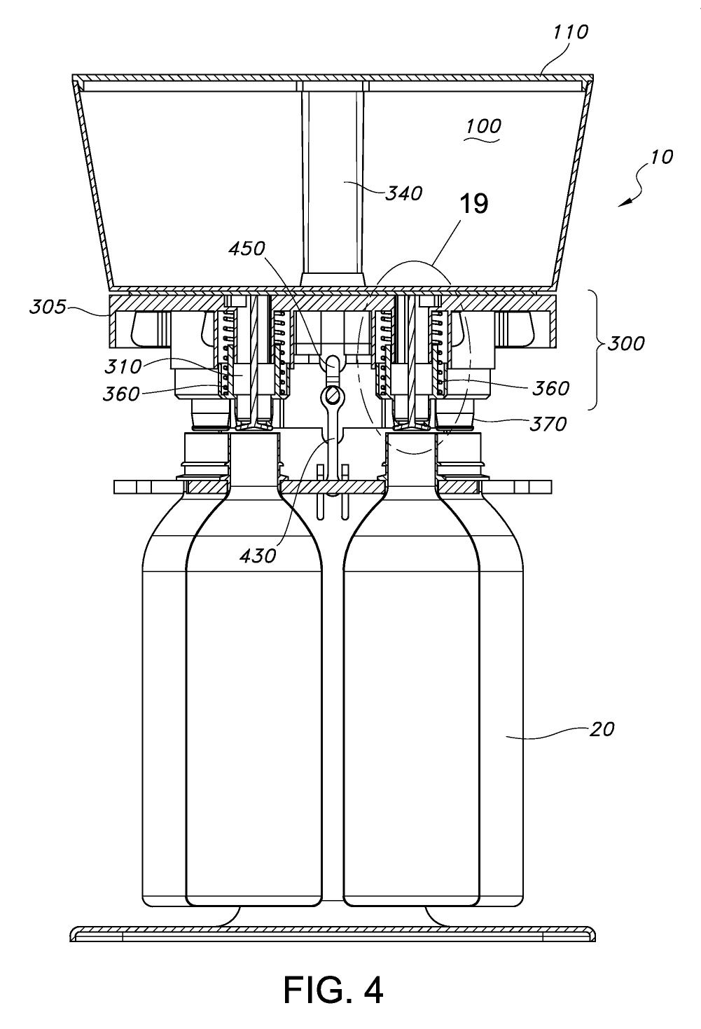

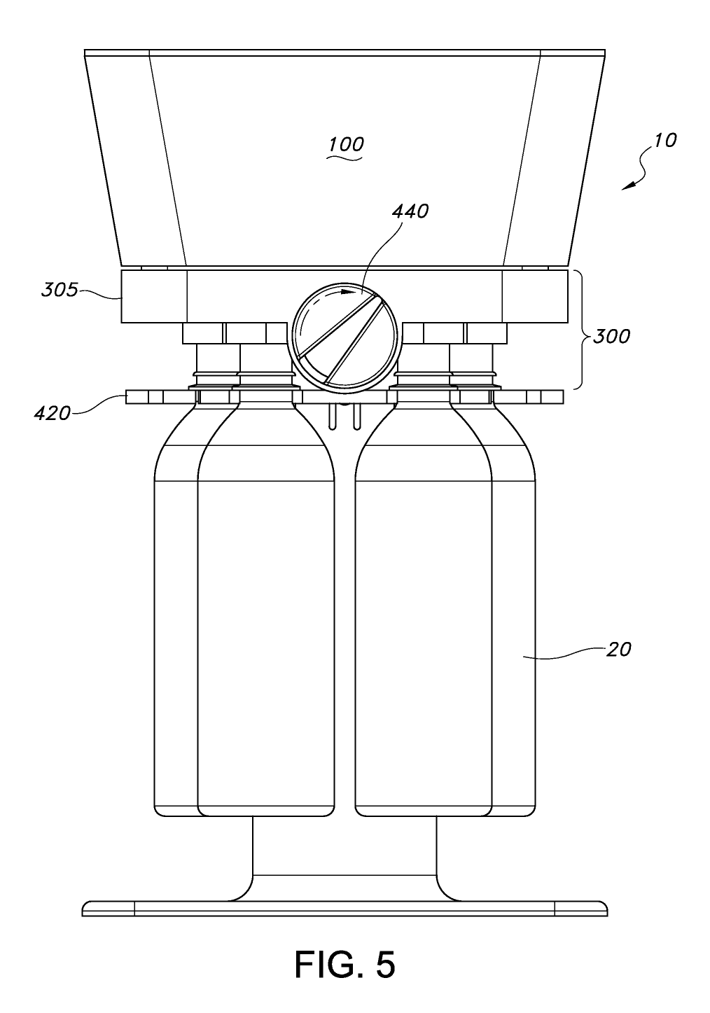

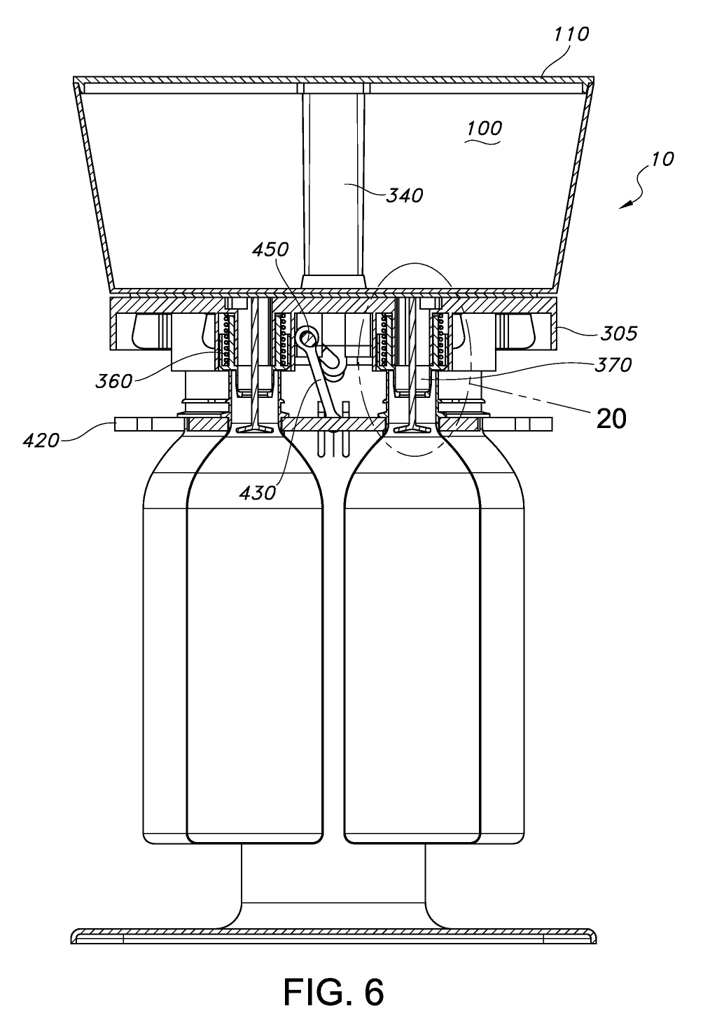

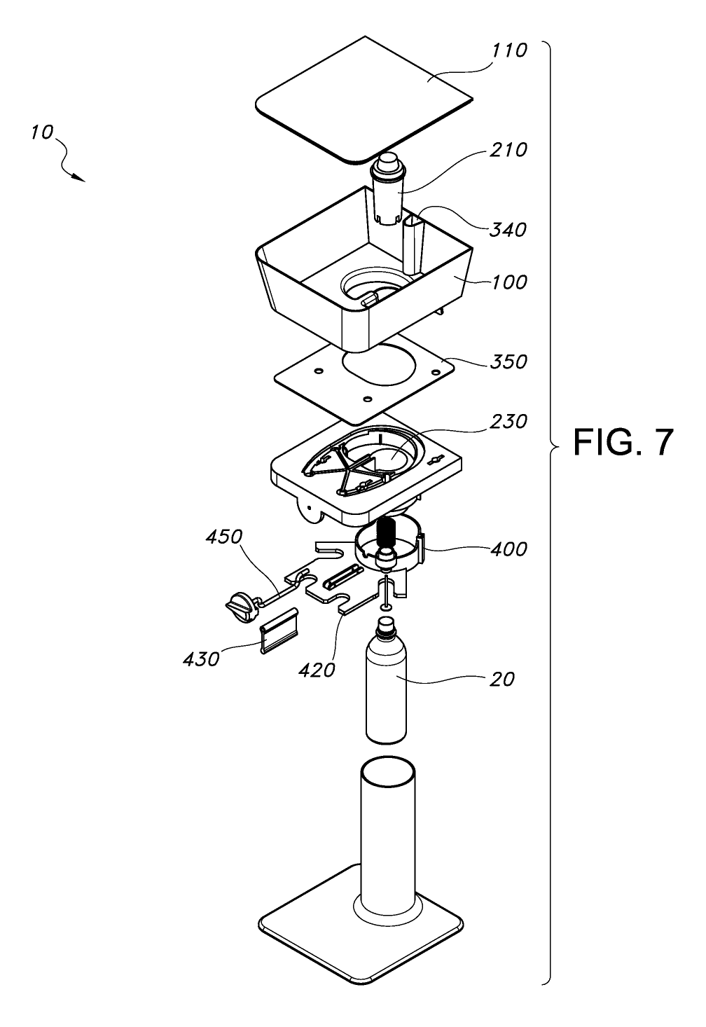

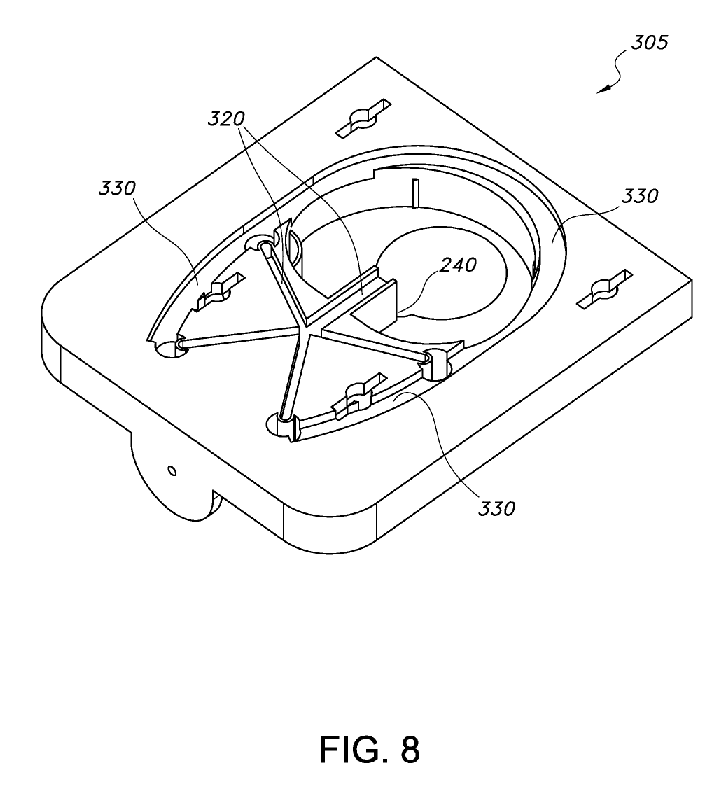

The dispensing assembly 300 is configured to dispense filtered water into the interior volume 26 of the at least one bottle 20. As illustrated in FIG. 2, the dispensing assembly can dispense filtered water into a plurality of bottles, as well. In one aspect, the dispensing assembly comprises at least one valve assembly 310 configured to move from an open position in which filtered water is permitted to flow therethrough, and a closed position in which filtered water is prevented from flowing therethrough. In configurations where there is more than one bottle, there can be a plurality of dispensing assemblies, each with their own valve assembly 310.

In one aspect, the valve assemblies can comprise any valve configuration known to those skilled in the art. In one aspect, as shown in FIGS. 20-21, the valve assemblies can comprise poppet valves.

In one exemplified aspect, there is at least one flow path 320 in communication with the filtration assembly and the dispensing assembly to permit the filtered water to flow from the filtration assembly to the dispensing assembly 300. The flow path 320 can, for example, comprise a closed flow tube or a flow channel. The at least one flow path can also comprise a plurality of flow paths in order to flow to a plurality of dispensing assembly for which to fill a plurality of bottles. As one skilled in the art can appreciate, the length of the flow paths can vary, thus varying the speed with which the resulting bottles will be filled. In one aspect, the flow paths 320 are substantially equal in length, providing substantially equal bottle fill rates.

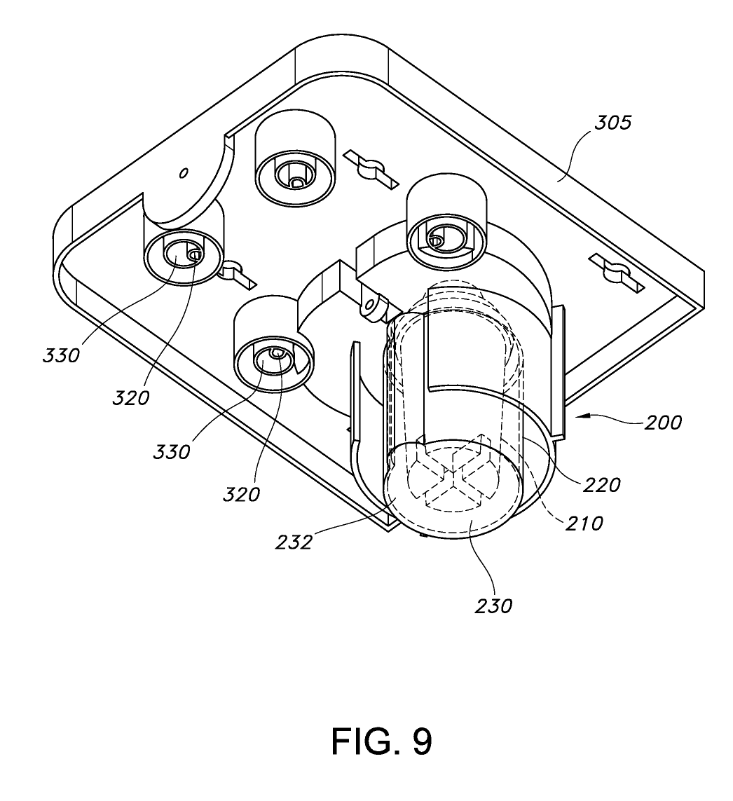

As each of the bottles 20 is filled with liquid, the volume of air contained within the interior volume of the bottle is displaced. In one aspect, the dispensing apparatus further comprises at least one vent channel 330 in communication with dispensing assembly and the atmosphere to permit air to flow from the interior volume of the bottle to the atmosphere when filtered water flows into the interior volume of the bottle. In another aspect, the at least one vent channel 330 vents to the atmosphere via a chimney 340. As can be seen in FIG. 9, the chimney 340, in one aspect, is positioned above the flow paths.

As can be appreciated, when the at least one valve of the dispensing assembly 300 is in the closed position, filtered water at least partially fills the at least one vent channel. In this aspect, the vent channel(s) and the chimney will fill to the natural level, equal to the water level of the reservoir 100. As such, in this aspect, upon opening the at least one valve, the filtered water in the at least one vent channel 330 flows into the interior volume 26 of the bottle at a rate greater than that of the filtered water via the flow path 320. In this fashion, this configuration can provide a quick fill function.

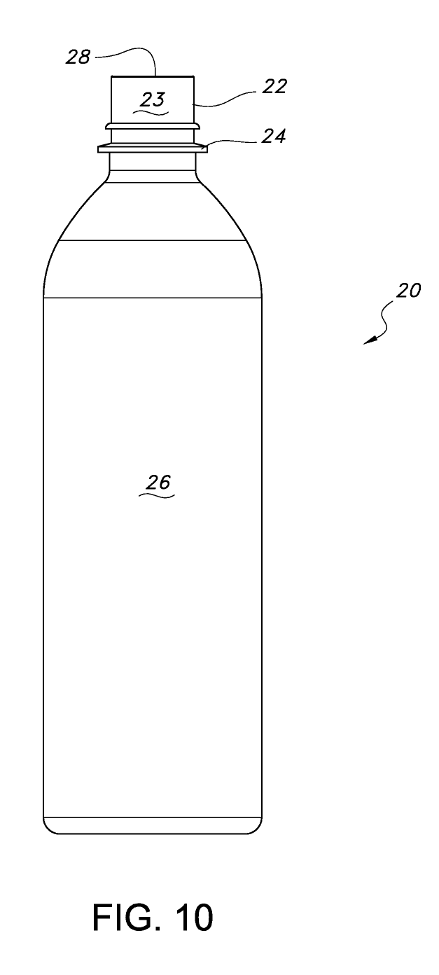

In one aspect, as shown in FIG. 10, the dispensing assembly is a manifold 305 for dispensing at least a portion of the filtered water into the interior volume of each of a plurality of bottles. The manifold 305 has a plurality of valve assemblies and a plurality of flow channels in communication with the filtration assembly 200 and the valve assembly to permit the filtered water to flow from the filtration assembly to the dispensing assembly. As such, in another aspect, the manifold also comprises a plurality of vent channels in communication with the dispensing assemblies and the atmosphere to permit air flow from the interior volume of each bottle to the atmosphere when filtered water flows into the interior volume of the bottle 20. In this aspect, as shown in FIG. 9, there can be a gasket 350 between the manifold 305 and the reservoir 100 to seal the flow channels and vent channels.

In one aspect, the bottle retention assembly 400 is configured to retain a portion of the at least one bottle in selective sealed engagement with a portion of the dispensing assembly 300 to permit filtered water to flow from the dispensing assembly into the interior volume of the bottle. The mouth 28 of the bottle 20 can be pressed up against a portion of the bottle retention assembly to seal the engagement. In another aspect, the seal comprises an o-ring 410 or similar device made of an elastomeric material.

As illustrated in FIG. 20, the valve assembly can be biased into the closed position using a bias element 360. One example of a bias element is a coil spring 360. In this aspect, a portion of the retention assembly, the retention plate 420, sits below the bead 24 of the bottle, holding it up. In this aspect, the bottle retention assembly 400 is positioned below the dispensing assembly and is configured to move from a lower, non-engaged position whereby at least one bottle 20 retained by the retention assembly is spaced therefrom the dispensing assembly 300, to a higher, engaged position whereby the at least one bottle is placed in sealed engagement with a portion of the dispensing assembly and to move the valve from the closed position to the open position to permit filtered water to flow from the dispensing assembly into the interior volume of the bottle. In doing so, the bias element 360 is biased by the mouth of the bottle and is bias a distance equal to the length of the neck 22 of the bottle. So, when the bottle 20 is removed out of engagement, the bias element will close the valve. Additionally, the valve assembly 310 can travel a valve distance 315 and continue to be in the open position substantially along the entire valve distance 315. This configuration permits the bottle retention assembly to accept at least one bottle having a range of neck lengths. In this aspect, the range of neck lengths is from about 0.25 inches to about 1.25 inches. In another aspect, the range of neck lengths is from about 0.35 inches to about 1.0 inches. In yet another aspect, the range of neck lengths is from about 0.4 inches to about 0.9 inches.

In an exemplified aspect, the dispensing assembly further comprises a volumizer 370 that extends into an interior portion of the neck 22 of the bottle when the bottle is engaged with a portion of the dispensing assembly 300. The volumizer 370 is configured to substantially occupy at least a portion of the neck volume 23 when the bottle is engaged with a portion of the dispensing assembly. In this aspect, upon disengagement of the bottle with a portion of the dispensing assembly, the at least one valve assembly moves from the open position to the closed position. As such, when the valve assembly moves from the open position to the closed position a volume of liquid enters the neck volume 23, the volume of liquid being less than the neck volume. In this fashion, since the seal is held via the spring 360 until the valve is closed, spilling from liquid being released during the closing of the valve is minimized or alleviated.

In one aspect, as shown in FIG. 2, the retention assembly 400 is connected to the dispensing assembly via a connector 430. The connector 430, in this aspect, is rotationally connected to both assemblies, as well as a retention knob 440. The connector can be a connecting rod, connecting plate, or other similar device. Turning the retention knob 440 moves the retention assembly upwardly to engaged the bottles into engagement with the dispensing assembly 300 via a camming action. In one exemplified aspect, the cam device 450 can travel approximately 180 degrees. The retention assembly can also have a portion that substantially wraps around a portion of the filtration assembly and is configured to slide up and down thereon. In this aspect, the filtration assembly is connected to and forms a portion of the base of the system.

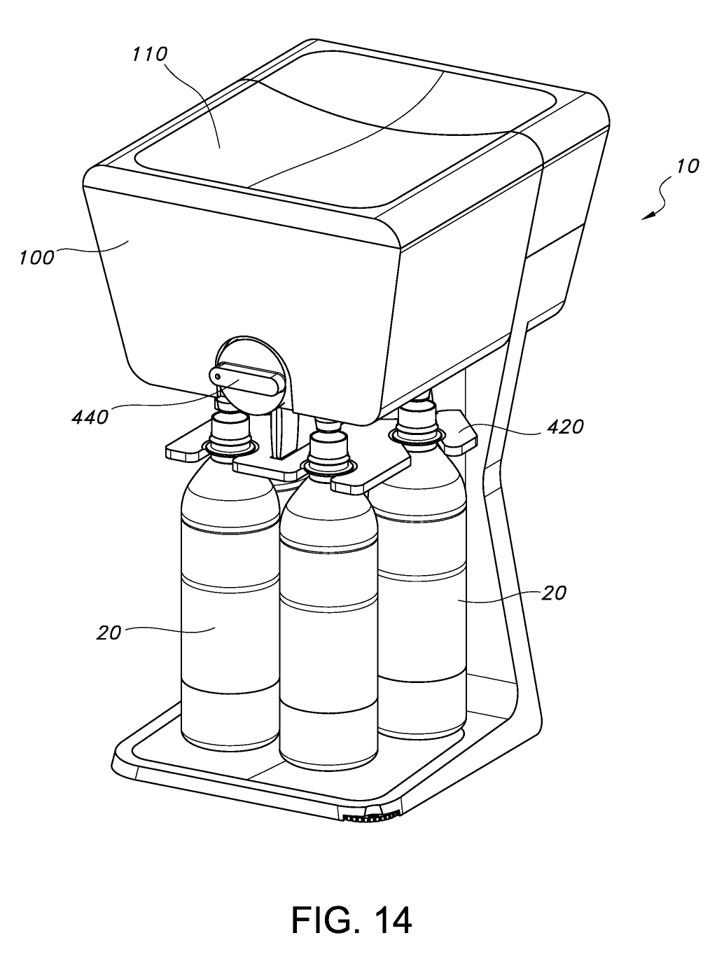

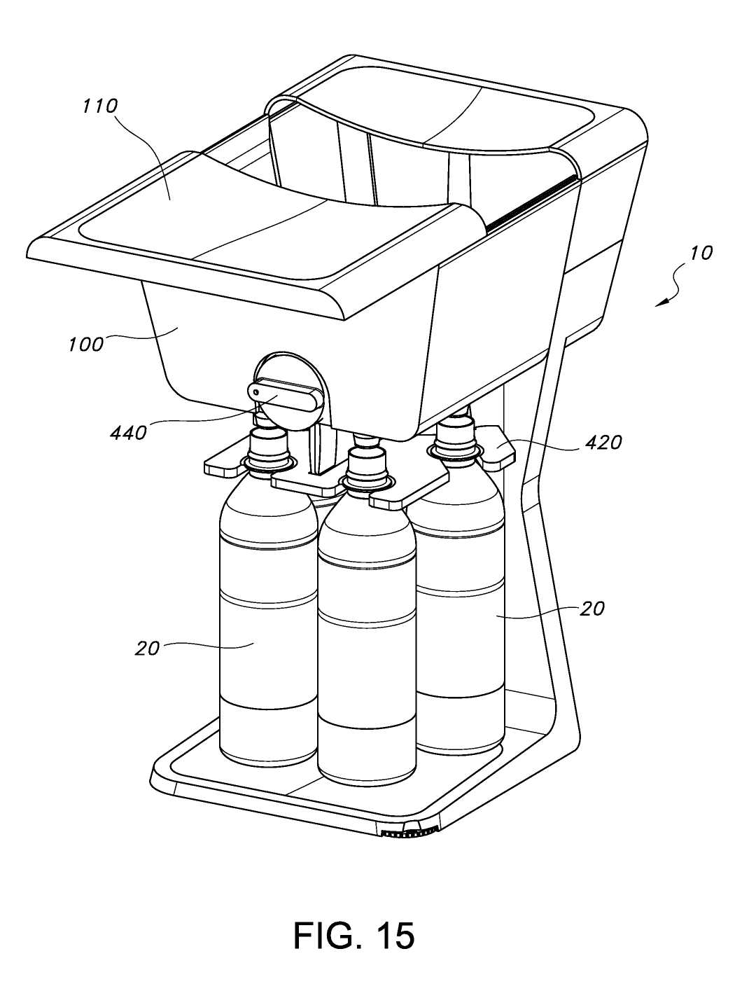

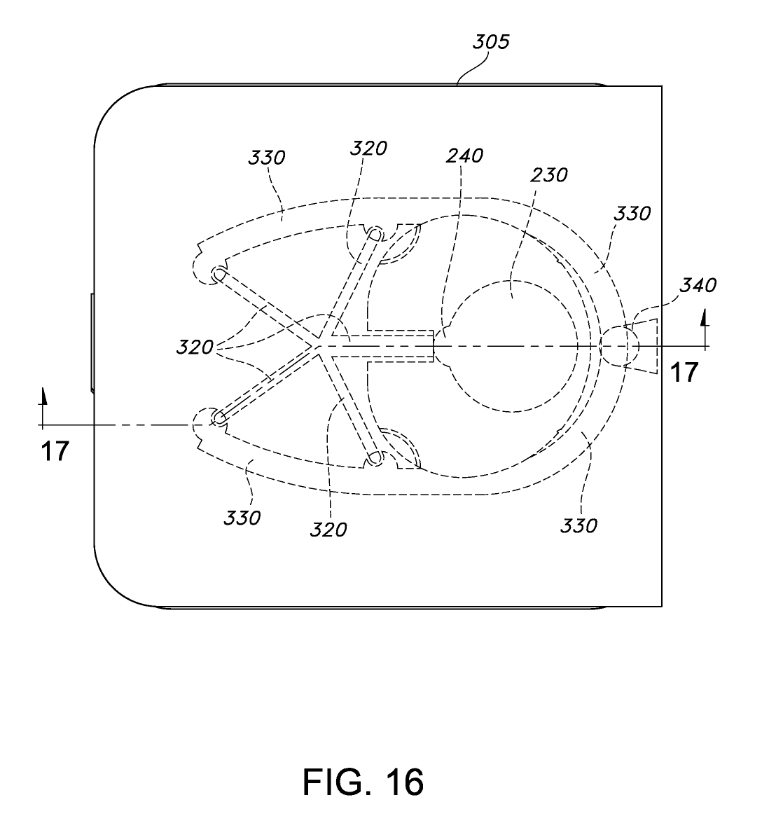

In another aspect, as shown in FIG. 14, the retention assembly can provide a ramp 460 to engage the bead of the bottle that aids to slide the neck 22 of the bottle upwardly toward the dispensing assembly. Other methods and modalities of moving the bottles into engagement with the dispensing assembly are also contemplated.

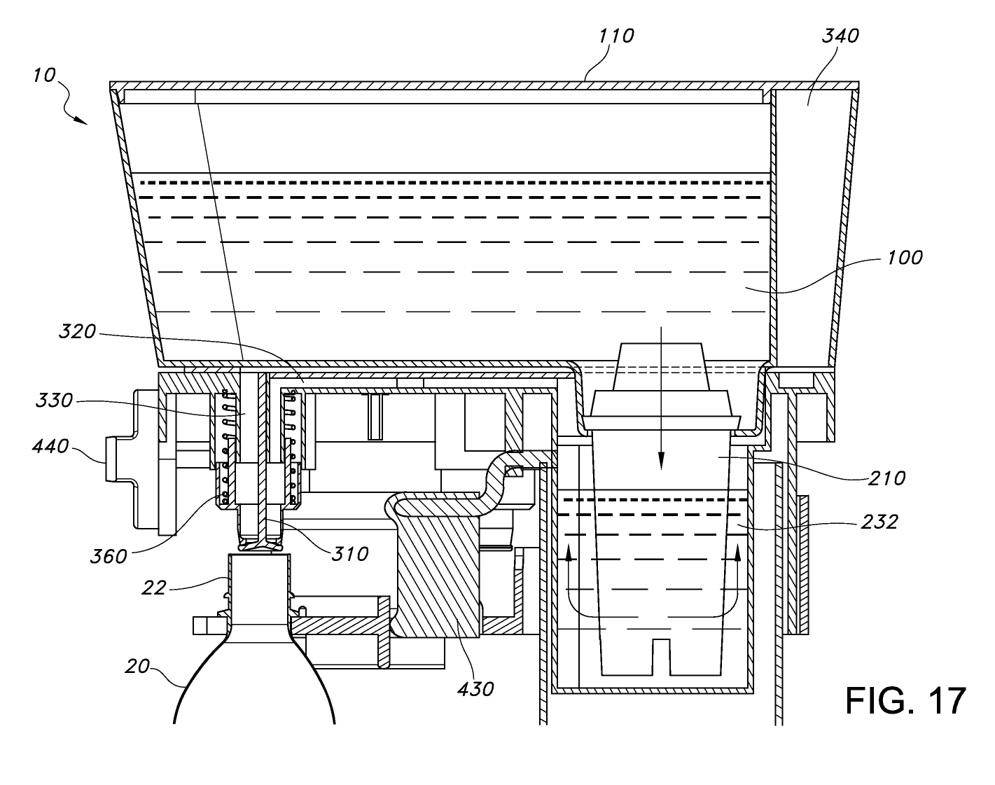

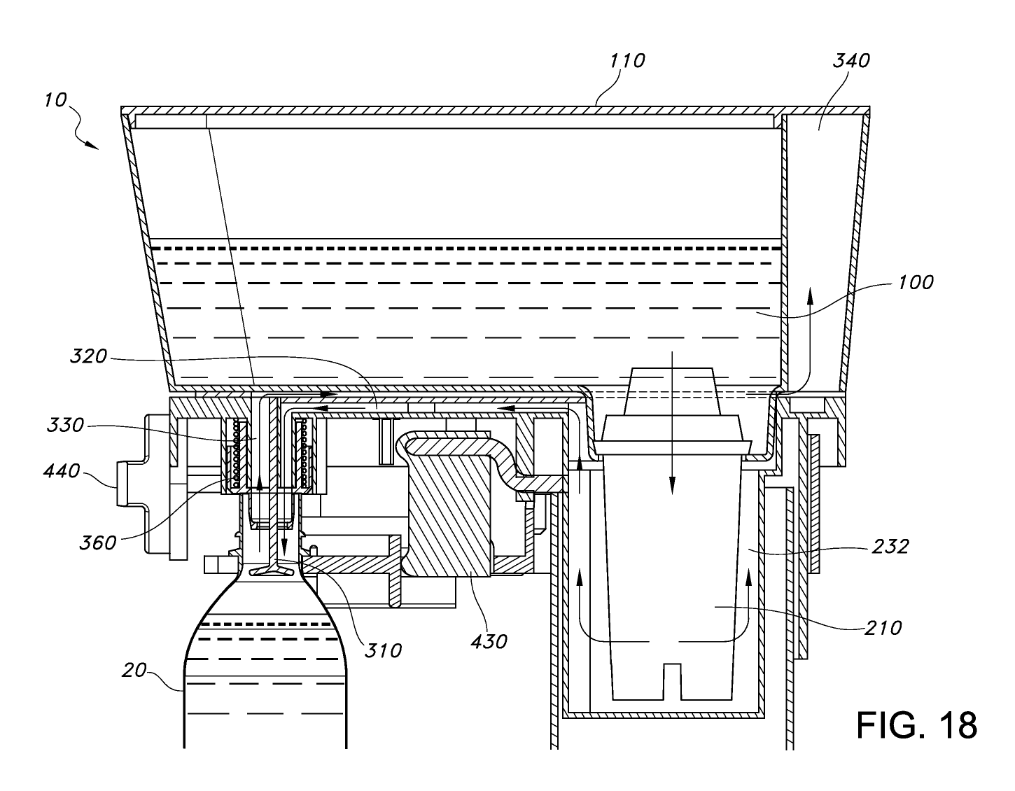

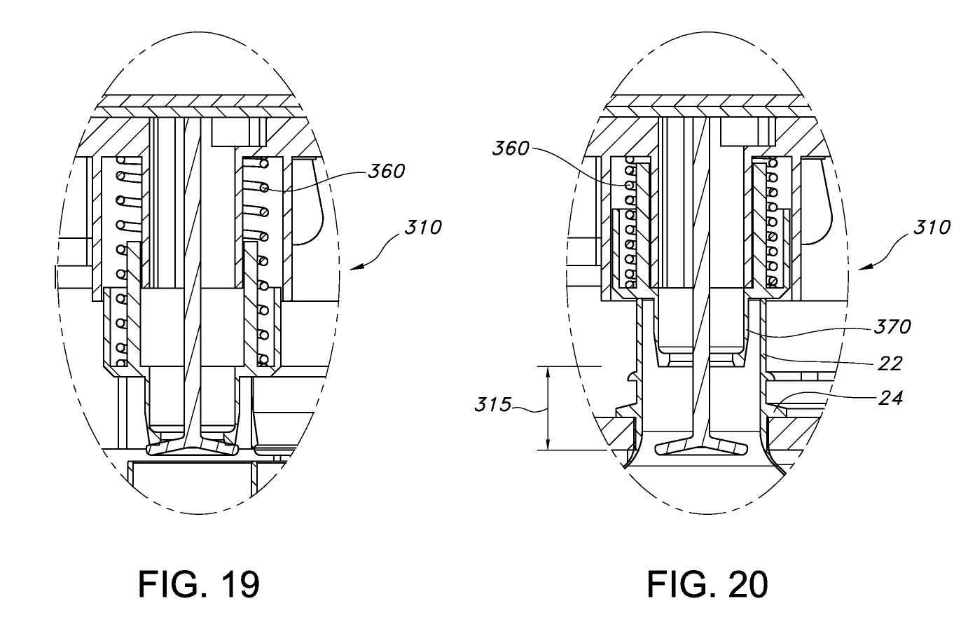

In yet another aspect, the dispensing apparatus 10 comprises a reservoir lid 110 configured to substantially enclose a top portion of the reservoir. In this aspect, the reservoir lid 110 is slidable in a horizontal direction to access an inner portion of the reservoir. As illustrated in FIG. 17, the top surface of the reservoir lid can form a flow path to direct liquid into the inner portion of the reservoir. This configuration makes it easier to fill the reservoir in configurations comprising reservoirs and essentially makes the lid a funnel.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

What is claimed is:

1. A liquid dispensing apparatus for filling at least one bottle with liquid, the bottle having a neck, a bead, an interior volume, and defining a mouth, the apparatus comprising:
an unfiltered water source to provide unfiltered water containing impurities;
a filtration assembly in fluid communication with the unfiltered water source, the filtration assembly configured to substantially filter at least some of the impurities from the water, providing filtered water;
a dispensing assembly for dispensing at least a portion of the filtered water into the interior volume of the at least one bottle, comprising at least one valve assembly configured to move from an open position in which filtered water is permitted to flow therethrough, and a closed position in which filtered water is prevented from flowing therethrough;
at least one flow path in communication with the filtration assembly and the dispensing assembly to permit the filtered water to flow from the filtration assembly to the dispensing assembly; and
a bottle retention assembly configured to retain a portion of the at least one bottle in selective sealed engagement with a portion of the dispensing assembly to permit filtered water to flow from the dispensing assembly into the interior volume of the bottle, wherein the bottle retention assembly is configured to accept at least one bottle having a range of neck lengths.

2. The dispensing apparatus of claim 1, wherein the dispensing assembly further comprises a volumizer that extends into an interior portion of the neck of the bottle when the bottle is engaged with a portion of the dispensing assembly.

3. The dispensing apparatus of claim 2, wherein the mouth and the neck of the bottle define a neck volume and wherein the volumizer substantially occupies at least a portion of the neck volume when the bottle is engaged with a portion of the dispensing assembly.

4. The dispensing apparatus of claim 3, wherein upon disengagement of the bottle with a portion of the dispensing assembly, the at least one valve assembly moves from the open position to the closed position, and wherein when the valve assembly moves from the open position to the closed position a volume of liquid enters the neck volume, the volume of liquid being less than the neck volume.

5. The dispensing apparatus of claim 1, wherein the range of neck lengths is from about 0.25 inches to about 1.25 inches.

6. The dispensing apparatus of claim 1, wherein the range of neck lengths is from about 0.35 inches to about 1.0 inches.

7. The dispensing apparatus of claim 1, wherein the range of neck lengths is from about 0.4 inches to about 0.9 inches.

8. The dispensing apparatus of claim 1, wherein the unfiltered water source comprises a reservoir configured to supply unfiltered water to the filtration assembly via gravity.

9. The dispensing apparatus of claim 8, further comprising a reservoir lid configured to substantially enclose a top portion of the reservoir.

10. The dispensing apparatus of claim 9, wherein the reservoir lid is slidable in a horizontal direction to access an inner portion of the reservoir and wherein a top surface of the reservoir lid forms a flow path to direct liquid into the inner portion of the reservoir.

11. The dispensing apparatus of claim 1, wherein the unfiltered water source comprises pressurized water.

12. The dispensing apparatus of claim 1, further comprising at least one vent channel in communication with dispensing assembly and the atmosphere to permit air to flow from the interior volume of the bottle to the atmosphere when filtered water flows into the interior volume of the bottle.

13. The dispensing apparatus of claim 12, wherein the at least one vent channel vents to the atmosphere via a chimney.

14. The dispensing apparatus of claim 12, wherein when the at least one valve is in the closed position, filtered water at least partially fills the at least one vent channel.

15. The dispensing apparatus of claim 14, wherein, upon opening the at least one valve, the filtered water in the at least one vent channel flows into the interior volume of the bottle at a rate greater than that of the filtered water via the flow path.

16. The dispensing apparatus of claim 1, wherein the at least one flow path comprises a plurality of flow paths and the dispensing assembly comprises a plurality of valve assemblies, wherein each flow path is in communication with a valve assembly.

17. The dispensing apparatus of claim 16, wherein each flow path is substantially equal in length.

18. The dispensing apparatus of claim 16, wherein the bottle retention assembly is configured to retain a portion of a plurality of bottles in selective sealed engagement with a portion of the dispensing assembly.

19. The dispensing apparatus of claim 18, wherein the bottle retention assembly is configured to retain a plurality of bottles and wherein two or more of the bottles have unequal neck lengths.

20. The dispensing apparatus of claim 1, wherein the bottle retention assembly is positioned below the dispensing assembly and is configured to move from a lower, non-engaged position whereby at least one bottle retained by the retention assembly is spaced therefrom the dispensing assembly, to a higher, engaged position whereby the at least one bottle is placed in sealed engagement with a portion of the dispensing assembly and to move the valve from the closed position to the open position to permit filtered water to flow from the dispensing assembly into the interior volume of the bottle.

21. A liquid dispensing apparatus for filling a plurality of bottles with liquid, each bottle having a neck, a bead, an interior volume, and defining a mouth, the apparatus comprising:
a reservoir for storing unfiltered water containing impurities;
a filtration assembly in communication with the unfiltered water source, the filtration assembly configured to substantially filter at least some of the impurities from the water, providing filtered water;
a manifold comprising a plurality of dispensing assemblies for dispensing at least a portion of the filtered water into the interior volume of each bottle, wherein each dispensing assembly comprises a valve assembly configured to move from an open position in which filtered water is permitted to flow therethrough, and a closed position in which filtered water is prevented from flowing therethrough, and wherein the manifold defines a plurality of flow channels in communication with the filtration assembly and the dispensing assembly to permit the filtered water to flow from the filtration assembly to the dispensing assembly, and wherein the manifold also comprises a plurality of vent channels in communication with the dispensing assemblies and the atmosphere to permit air flow from the interior volume of each bottle to the atmosphere when filtered water flows into the interior volume of the bottle; and
a bottle retention assembly configured to retain a portion of each bottle in selective sealed engagement with a portion of the dispensing assembly to permit filtered water to flow from the dispensing assembly into the interior volume of the bottle.

22. The dispensing apparatus of claim 21, wherein the bottle retention assembly is configured to accept bottles having a range of neck lengths.

23. The dispensing apparatus of claim 22, wherein the range of neck lengths is from about 0.25 inches to about 1.25 inches.

24. The dispensing apparatus of claim 22, wherein the range of neck lengths is from about 0.35 inches to about 1.0 inches.

25. The dispensing apparatus of claim 22, wherein the range of neck lengths is from about 0.4 inches to about 0.9 inches.

26. The dispensing apparatus of claim 21, wherein the reservoir is configured to supply unfiltered water to the filtration assembly via gravity.

27. The dispensing apparatus of claim 21, wherein the vent channels vent to the atmosphere via a chimney.

28. The dispensing apparatus of claim 21, wherein each flow path is substantially equal in length.

29. The dispensing apparatus of claim 21, wherein the bottle retention assembly is configured to retain a portion of a plurality of bottles in selective sealed engagement with a portion of the dispensing assembly.

30. The dispensing apparatus of claim 29, wherein the bottle retention assembly is configured to retain a plurality of bottles and wherein two or more of the bottles have unequal neck lengths.

31. The dispensing apparatus of claim 30, wherein the bottle retention assembly is positioned below the dispensing assembly and is configured to move from a lower, non-engaged position whereby the plurality of bottles retained by the retention assembly are spaced therefrom the dispensing assembly, to a higher, engaged position whereby the plurality of bottles are placed in sealed engagement with a portion of the dispensing assembly and to move the valve from the closed position to the open position to permit filtered water to flow from the dispensing assembly into the interior volume of the bottle.

32. The dispensing apparatus of claim 30, wherein the bottle retention assembly comprises a plurality of bottle retention assemblies, each configured to retain one bottle.

33. The dispensing apparatus of claim 21, wherein the filtration assembly is configured to supply filtered water to the flow channels via artesian effect.

34. The dispensing apparatus of claim 21, wherein the filtration assembly is configured to supply filtered water to the flow channels using a pump.

35. The dispensing apparatus of claim 21, further comprising a reservoir lid configured to substantially enclose a top portion of the reservoir.

36. The dispensing apparatus of claim 35, wherein the reservoir lid is slidable in a horizontal direction to access an inner portion of the reservoir and wherein a top surface of the reservoir lid forms a flow path to direct liquid into the inner portion of the reservoir.
